(19) United States
(12) Patent Application Publication
(10) Pub. No.: US 2007/0012508 A1
(43) Pub. Date: Jan. 18, 2007

(54) Impact resistance acoustic treatment

(76) Inventor: Christopher G. Demers, Willington, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/181,226

(22) Filed: Jul. 13, 2005

(51) Int. Cl. E04H 17/00; B64F 1/26; G10K 11/00; E04B 1/82

(52) U.S. Cl. 181/210; 181/293

(57) ABSTRACT

A liner assembly for a duct includes noise attenuation panel for dissipating sound energy generated within the duct. A damage resistant acoustic panel for installation in high velocity impact prone locations includes a plurality of openings for communicating noise signals to the noise attenuation panel. At lease some of the openings includes a first diameter that extends a depth into the acoustic panel. The depth is no greater than the first diameter. A second portion extends the remainder of the thickness into the acoustic panel and includes a diameter greater than the first diameter. The increased area provided by the second diameter reduces restriction to the transmission of sound energy to the noise attenuation panel within an acoustic panel thickness required for protecting against foreign object damage.

### BACKGROUND OF THE INVENTION

This application generally relates to an acoustic liner for a duct. More particularly, this application relates to an acoustic panel for impact prone areas of a duct.

Conventional turbine and turbofan engines for aircraft include a plurality of fan blades that rotate within a duct commonly known as a fan case. The fan case serves as a protective covering to protect the fan blades and the aircraft. Further the fan case channels airflow into the turbine engine. The inner surface of the fan case is constructed to withstand impacts from objects that may come into contact with the fan case and includes acoustical features to reduce the noise emitted from the engine.

The placement of the acoustical features is limited in use to areas of the case that are protected from impact by foreign objects such as shed ice. A noise attenuation layer is covered by a face layer including a plurality of openings. The face layer is typically a thin sheet of metal or composite material mounted over the noise attenuation layer. Noise signals, i.e. pressure disturbances enter the noise attenuation layer by way of the openings in the face layer. The noise attenuation layer dissipates the pressure disturbances to reduce the total amount of noise. It is the plurality of openings in the face layer that weaken the structure and limit use of the noise attenuation structure to protected areas such as forward of the fan blades.

It is for this reason that portions of the liner assembly that are prone to foreign object impact are formed from hardened and well supported solid surfaces. The use of the solid surface limits the effectiveness and possible locations of sound treatments within the liner assembly.

Accordingly, it is desirable to develop a damage resistant acoustically active panel for use in areas of the liner assembly that are vulnerable to foreign object damage.

### SUMMARY OF THE INVENTION

An example fan case assembly according to this invention includes a liner assembly having a damage resistant acoustically active panel.

The liner assembly includes noise attenuation layers for dissipating sound energy generated within the fan case assembly. The noise attenuation layer is covered by a face sheet. The face sheet includes a plurality of openings that communicate sound energy to the underlying noise attenuation structure. The thickness of the face sheet is less than or equal to a diameter of the plurality of openings to provide the desired noise abatement properties. The thin face sheet is vulnerable to high velocity impacts and therefore is not utilized in areas of the liner assembly that are prone to high velocity impact from foreign objects.

The damage resistant acoustic panel includes a thickness that is provided to withstand high velocity impact from foreign objects and includes at least one opening having a first diameter beginning at the flow path wall that is less than a second diameter adjacent the underlying noise attenuation structure. The opening therefore includes a variable diameter that increases in a direction toward the noise attenuation structure. The first diameter extends from the flow path wall toward the noise attenuation layer a depth. The depth is no more than the first diameter to provide the desired opening to thickness ratio for the desired acoustic performance.

The second diameter is greater than the first diameter. The amount to which the second diameter is greater than the first diameter is determined to provide a substantially open and unrestricted passage for sound energy entering the openings. The second diameter is greater to reduce restriction to sound energy through to the noise attenuation structure.

Accordingly, the liner assembly of this invention provides an acoustically active panel that provides the desired strength to protect against impacts and foreign object damage.

These and other features of the present invention can be best understood from the following specification and drawings, the following of which is a brief description.

### BRIEF DESCRIPTION OF THE DRAWINGS

FIG. 1 is a partial cross-section of a duct and a liner assembly according to this invention.

FIG. 2 is a cross-sectional view of a portion of an acoustically active panel for use in areas requiring protection form impact.

FIG. 3 is a cross-sectional view of an opening for the acoustically active panel.

FIG. 4 is another cross-sectional view of an opening for the acoustically active panel.

### DETAILED DESCRIPTION OF THE PREFERRED EMBODIMENT

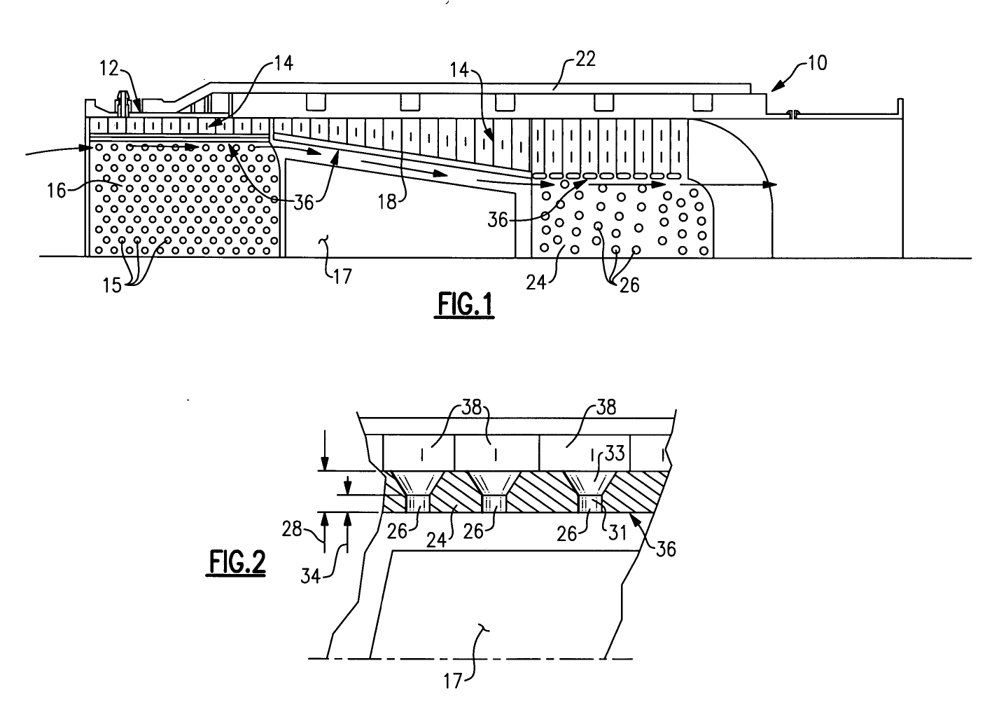

Referring to FIG. 1 a fan case assembly 10 includes a liner assembly 12. The liner assembly 12 includes a noise attenuation panel 14 for dissipating sound energy generated within the fan case assembly 10. Although this invention is described by way of example for a fan case assembly 10 other duct structures having acoustic treatments will benefit from this disclosure.

The noise attenuation layer 14 is covered by a flow path wall 36 comprising a perforated face sheet 16 and the acoustic honeycomb noise attenuation panel 14. Flow through the fan case assembly and along the flow path wall 36 begins at a position forward of a fan blade 17. The face sheet 16 is generally forward of a fan blade 17. The abradable strip 18 is orientated rearward of the face sheet 16 in a location adjacent the fan blade 17. Further rearward of the abradable strip 18 and the fan blade 17 is the acoustic panel 24.

The face sheet 16 includes a plurality of openings 15 that communicate sound energy to the underlying noise attenuation panel 14. The thickness of the face sheet 16 is less than or equal to a width of at least some of the plurality of openings 15 to provide the desired noise abatement properties. However, the plurality of openings 15 are disposed in such a density as to reduce the impact resistance of the face sheet 16. Accordingly, the face sheet 16 is not utilized in areas of the liner assembly 12 that are prone to high velocity impact from foreign objects. The configuration and thickness of the face sheet 16 that provides the desired acoustic properties in not suitable for resisting damage from high velocity impacts.

The region rearward of the fan blade 17 is vulnerable to high velocity impacts. The fan blade 17 rotates adjacent the abradable strip 18 and therefore the flow path wall 36 to the rear of the abradable strip 18 must be capable of withstanding impacts from foreign objects accelerated to a high velocity by the fan blade 17. For this reason the thickness of a acoustic panel facesheet 24 is greater than that of the face sheet 16.

Openings within the acoustic panel facesheet 24 cannot be of such a size and density so as to effectively weaken the panel 24 and degrade its impact resistance. However, the depth of the openings cannot be greater than the openings and still provide the desired acoustic properties. In thinner panels, the diameter of the openings is easily larger than the depth. However, openings within the thicker panels are not. Accordingly, such conflicting requirements have prevented the use of acoustic treatment in impact prone areas, because the use of holes capable of providing the necessary acoustic properties would so weaken the panel as to render the panel undesirable for impact protection purposes.

The panel 24 of this invention includes at least one opening 26 that has a first portion with a maximum width beginning at the flow path wall 34 and a depth. The opening 26 can be round, in which case the maximum width will be a diameter or a non-round shape in which case the longest dimension will be no larger than the maximum width. The depth of the first portion is no more than the maximum width. The maximum width measured within a plane defined parallel to the surface 36 of the panel 24. The opening 26 also includes a second portion that includes a minimum width that is greater than or equal to the maximum width. The second portion extends from the depth toward the underlying noise attenuation panel 14. The opening 26 therefore includes a variable area that increases in a direction toward the noise attenuation panel 14.

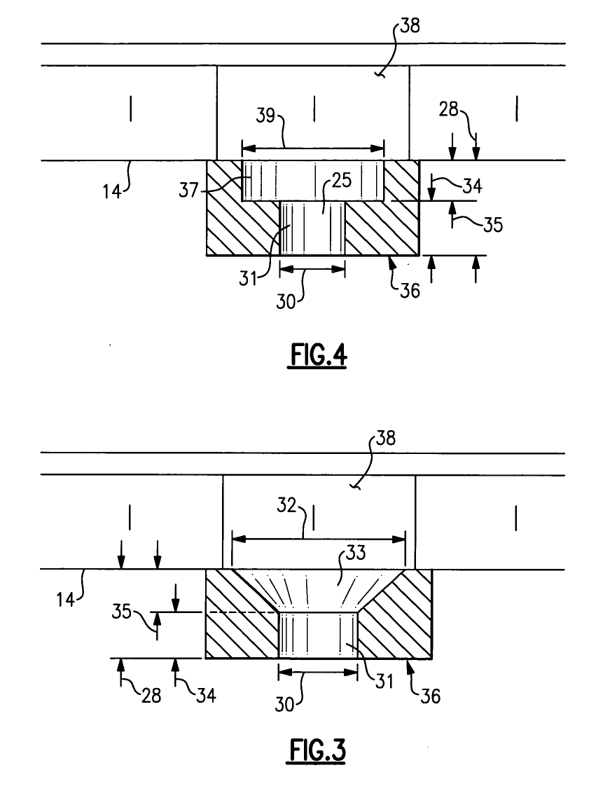

Referring to FIGS. 2 and 3, the panel 24 includes a plurality of the openings 26 disposed in densities sufficient to provide the desired acoustic properties and communicate sound energy to the underlying noise attenuation panel 14. The openings 26 are shown and described as round holes, however it is within the contemplation of this invention that the openings may be of any shape that would include a maximum width.

The noise attenuation panel 14 includes a plurality of cavities 38, each of which is in communication with at least one of the openings 26. The openings 26 include the first portion 31 that extends from the flow path wall 36 toward the noise attenuation panel 14 a depth 34. The depth 34 is less than or equal to a first diameter 30 of the first portion 31. The first diameter 30 is the maximum diameter provided in the first portion 31. The first diameter 30 in this example is constant for the depth 34. A ratio between the maximum diameter 30 and the depth 34 is no more than one to one. That is the depth 34 is substantially equal to or less than the first diameter 30 of the first portion 31.

The openings 26 include the second portion 33 having a second diameter 32 that is greater than the first diameter 30 of the first opening 31. The second diameter 32 includes at least some portion that is greater than the first diameter 30, and no portion that is less. In the example second portion 33 illustrated in FIGS. 2 and 3, the second diameter 32 varies in an increasing manner beginning from the depth 34 toward the side adjacent the nose attenuation panel 14. The amount that the second diameter 32 is greater than the first diameter 30 is determined to provide a substantially open and unrestricted passage for sound energy emanating through the openings 26.

The second portion 33 includes the larger second diameter 32 to reduce restriction to sound energy traveling through to the noise attenuation panel 14. The example second portion 33 comprises an increasing second diameter 32 forming a chamfered shape. The second diameter 32 extends through the remaining thickness 35 of the panel 24, whatever the thickness of the panel 24.

The panel 24 includes an overall thickness 28 that is determined to provide the required impact protection. In one example the panel thickness 28 is approximately ⅛^{th} of an inch. However, other thicknesses as are required are within the contemplation of this invention.

Referring to FIG. 4, another example opening 25 is shown and includes a stepped diameter. The first portion 31 includes the first diameter 30 as described with reference to FIG. 3. The depth 34 of the first diameter 30 of the first portion 31 is less than or equal to the first diameter 30 to provide the desired acoustic performance and communicate sound energy to the noise attenuation layer 14.

The opening 25 includes a second portion 37 having a second diameter 39 that is constant beginning from the depth 34 for the remaining thickness 35 adjacent the noise attenuation layer 14. The diameter or maximum width of the opening 25 therefore, increases in a direction toward the noise attenuation panel 14, with the second diameter 39 being constant instead of variable and increasing as is shown in FIG. 3.

The shape of the openings 25, 26 in the example described and shown is round, however other opening shapes such as square, oval or polygonal can be utilized and are within the contemplation of this invention. Further, the contoured shape of the opening and increasing area in the direction toward the noise attenuation panel 14 can vary from the examples described and shown and are also within the contemplation of this invention.

Accordingly, the liner assembly 12 of this invention provides an acoustically active panel 24 that provides the desired strength to protect against impacts and foreign object damage.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A liner assembly for a duct comprising:
a noise attenuation panel;
a facesheet panel covering said noise attenuation layer; and
a plurality of openings defined within said facesheet panel, wherein at least some of said plurality openings include a first portion having a maximum width and a depth, and a second portion having a minimum width no less than said maximum width, wherein said depth is no more than said maximum width.

2. The assembly as recited in claim 1, wherein said maximum width is substantially equal to said depth.

3. The assembly as recited in claim 1, wherein said facesheet panel includes a thickness and said depth is less than said thickness.

4. The assembly as recited in claim 1, wherein said second portion comprises a variable diameter increasing in a direction toward said noise attenuation panel.

5. The assembly as recited in claim 1, including a plurality of facesheet panels disposed within said duct for covering a portion of said noise attenuation panel.

6. The assembly as recited in claim 1, wherein said maximum width and said minimum width are parallel to a surface of said facesheet panel.

7. The assembly as recited in claim 1 wherein said first portion and said second portion are substantially round.

8. The assembly as recited in claim 1, wherein said first portion and said second portion are substantially rectangular.

9. A facesheet panel assembly for covering a noise attenuation panel, said facesheet panel assembly comprising:
a plurality of openings for communicating sound energy to said noise attenuation layer, wherein at least some of said plurality of openings include a first diameter extending from a first surface of said facesheet panel assembly a first depth, and a second diameter greater than said first diameter extending from said first depth in a direction toward said noise attenuation layer, wherein said first depth is no greater than said first diameter.

10. The assembly as recited in claim 9, wherein said facesheet panel assembly includes a thickness and said first depth is less then said thickness.

11. The assembly as recited in claim 10, wherein said first depth is substantially equal to said first diameter.

12. The assembly as recited in claim 9, wherein said second diameter comprises a diameter increasing in a direction toward said noise attenuation panel.

13. The assembly as recited in claim 12, wherein said second diameter comprises an increasing diameter toward the noise attenuation panel.

14. The assembly as recited in claim 9, wherein said second diameter is constant between said first depth and a surface of said facesheet panel assembly facing the noise attenuation layer.
